(19) United States
(12) Patent Application Publication
(10) Pub. No.: US 2026/0075136 A1
(43) Pub. Date: Mar. 12, 2026

(54) SYSTEMS FOR CALLER IDENTIFICATION AND ASSOCIATED METHODS

(71) Applicant: AVOXI, INC., Atlanta, GA (US)

(72) Inventors: Randy Layman, Marietta, GA (US); David Schmitt, Lee's Summit, MO (US); Mitchell Ramsey, Lake Wylie, SC (US); Ethan Dam, Lawrenceville, GA (US); Matt Kirstein, Roswell, GA (US); Janice McDonnell Marra, Ringoes, NJ (US)

(21) Appl. No.: 18/882,873

(22) Filed: Sep. 12, 2024

(51) Int. Cl. H04M 3/42; H04L 65/1104

(52) U.S. Cl. CPC H04M 3/42008; H04L 65/1104

(57) ABSTRACT

A communications system may include one or more processors coupled to memory. The one or more processors may be collectively operable to execute a communications environment. The communications environment may be operable to receive a request to place an outbound call from an outbound telephone number to a specified telephone number. The communications environment may be operable to assign a caller identification number from a set of caller identification numbers to the outbound call based on one or more criterion associated with at least one prior call relating to the specified telephone number. A method of caller identification is also disclosed.

### BACKGROUND

This disclosure relates to (e.g., telephone) communications systems, including techniques for caller identification (ID).

Sales teams and contact center agents may place outbound calls to contact prospects and customers. Caller ID is a feature that displays the phone number associated with an incoming telephone call, which can be viewed by the callee to screen the call. The callee may be less likely to answer the call due to the increasing frequency of spam calls. An efficiency of the sales or contact agent may be reduced if the callee does not answer the respective call.

### SUMMARY

Implementations of the systems and/or methods disclosed herein may be utilized to assign caller identification (ID) numbers to outbound calls.

A communications system may include one or more processors coupled to memory. The one or more processors may be collectively operable to execute a communications environment. The communications environment may be operable to receive a request to place an outbound call from an outbound telephone number to a specified telephone number. The communications environment may be operable to assign a caller identification number from a set of caller identification numbers to the outbound call based on one or more criterion that may be associated with at least one prior call relating to the specified telephone number. The caller identification number may differ from the outbound telephone number. The communications environment may be operable to place the outbound call from the outbound telephone number to the specified telephone number using the assigned caller identification number.

A method of caller identification may include receiving a request to place an outbound call from an outbound telephone number to a specified telephone number. The method may include assigning a caller identification number from a set of caller identification numbers to the outbound call based on at least one prior call relating to the specified telephone number. The caller identification number may differ from the outbound telephone number. The method may include placing the outbound call to the specified telephone number using the assigned caller identification number.

The present disclosure may include any one or more of the individual features disclosed above and/or below alone or in any combination thereof.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 discloses a communications system.

FIG. 2 discloses a system for caller identification.

FIG. 3 discloses a user interface according to an implementation.

FIG. 4 discloses a method of caller identification.

FIG. 5 discloses a method of caller identification according to another implementation.

Like reference numbers and designations in the various drawings indicate like elements.

### DETAILED DESCRIPTION

The disclosed systems and methods may be utilized to assign caller identification (ID) numbers to outbound calls.

A communications (e.g., telephone) system (e.g., network) may be assigned (e.g., allocated) a set of telephone numbers, which may be utilized by one or more communications (e.g., telephone) devices to place a telephone call. The telephone devices may be associated with a respective communications (e.g., client or customer) network. The system may be operable to interconnect the client network and one or more other telephone networks, which may be associated with one or more telephone devices. The system may be operable to establish the connection utilizing various techniques, including voice over internet protocol (VoIP).

Modern organizations may have large sets of phone numbers to support the sales and support operations around the world. Agents could potentially use any one of these numbers to call a prospect or customer. The disclosed techniques may be utilized to dynamically assign caller ID numbers (e.g., caller IDs) to respective outbound calls based on one or more criterion, which may improve a likelihood that the calls may be answered.

The system may be operable to execute one or more telephone services, including caller ID. The caller ID service may be operable to assign a caller ID number to an (e.g., outbound) telephone number associated with a telephone device of the caller, which may be associated with the client network. The caller ID service may be operable to configuring one or more parameters of an outbound call. The parameters may include an external phone number field. In implementations, the system may be operable to store the assigned caller ID number in the external phone number field. The caller ID service may be operable to transmit the assigned caller ID number to a communications (e.g., telephone) device associated with the callee, which may occur subsequent to configuring the parameter(s) of the outbound call. The caller ID service may include a Calling Name Presentation (CNAM) service operable to communicate a name associated with the assigned caller ID to the telephone device of the caller. The CNAM service may be operable to query the caller ID number in a caller ID database to confirm registration.

The assigned caller ID number may be the same or may differ from the telephone number that may place the outbound call. The system may be operable to use the caller ID number for a single telephone number at a time, and/or may be operable to use the same caller ID number for more than one telephone number at the same time.

The disclosed systems and methods may be operable to dynamically assign caller ID numbers in response to initiating (e.g., attempting) outbound calls. In implementations, the system may be operable to assign a caller ID number based on one or more criterion, including one or more (e.g., predefined) rules, which may include any of the rules disclosed herein. The rules may be associated with a (e.g., predefined) hierarchy. The caller ID number may be assigned according to the hierarchy.

A communications system may include one or more processors coupled to memory. The one or more processors may be collectively operable to execute a communications environment. The communications environment may be operable to receive a request to place an outbound call from an outbound telephone number to a specified telephone number. The communications environment may be operable to assign a caller identification number from a set of caller identification numbers to the outbound call based on one or more criterion that may be associated with at least one prior call relating to the specified telephone number. The caller identification number may differ from the outbound telephone number. The communications environment may be operable to place the outbound call from the outbound telephone number to the specified telephone number using the assigned caller identification number.

In any implementations, a Session Initiation Protocol (SIP) server may include the one or more processors.

In any implementations, the communications environment may be operable to query a list of prior calls to and/or from a first network associated with the outbound telephone number. Each entry of the list of prior calls may be associated with a respective caller identification number of the set of caller identification numbers. The communications environment may be operable identify at least one entry in the list of prior calls associated with the specified telephone number. The communications environment may be operable assign the caller identification number associated with the at least one entry to the outbound call.

In any implementations, the communications environment may be operable to assign the caller identification number associated with a most recent call in the list of prior calls associated with the specified telephone number in response to identifying the at least one entry in the list of prior calls associated with the specified telephone number.

In any implementations, the list of prior calls may include one or more inbound calls.

In any implementations, the one or more inbound calls may include at least one inbound call placed by the specified telephone number.

In any implementations, the list of prior calls may include one or more answered outbound calls placed by one or more devices of the first network.

In any implementations, the communications environment may be operable to filter the entries in the list of prior calls based on one or more caller identification restrictions associated with the specified telephone number. The communications environment may be operable to assign the caller identification number associated with the at least one entry to the outbound call based on the filter.

In any implementations, the one or more caller identification restrictions may be associated with a geographic location of the specified telephone number.

In any implementations, the geographic location may include a country and/or region of the specified telephone number.

In any implementations, the communications environment may be operable to identify a geographic location associated with the specified telephone number. The communications environment may be operable to determine an answer rate for each caller identification number of the set of caller identification numbers associated with the geographic location. communications environment may be operable to assign the caller identification number associated with the highest determined answer rate to the outbound call.

In any implementations, the communications environment may be operable to limit the set of caller identification numbers to one or more prior time periods relating to a time period of a request to place the outbound call.

In any implementations, the one or more criterion may include a set of rules associated with a hierarchy. The communications environment may be operable to assign the caller identification number based on the hierarchy.

A method of caller identification may include receiving a request to place an outbound call from an outbound telephone number to a specified telephone number. The method may include assigning a caller identification number from a set of caller identification numbers to the outbound call based on at least one prior call relating to the specified telephone number. The caller identification number may differ from the outbound telephone number. The method may include placing the outbound call to the specified telephone number using the assigned caller identification number.

In any implementations, the assigning step may be performed by a Session Initiation Protocol (SIP) server that may interconnect a first device associated with the outbound telephone number and a second device associated with the specified telephone number.

In any implementations, the assigning step may include querying a list of prior calls associated with the outbound telephone number. Each entry of the list of prior calls may be associated with a respective caller identification number of the set of caller identification numbers. The assigning step may include identifying at least one entry in the list of prior calls associated with the specified telephone number. The assigning step may include assigning the caller identification number associated with the at least one entry to the outbound call.

In any implementations, the assigning step may include determining a most recent call in the list of prior calls from the specified telephone number. The assigning step may include assigning the caller identification number associated with the most recent call to the outbound call.

In any implementations, the assigning step may include identifying a geographic location associated with the specified telephone number. The assigning step may include determining an answer rate associated with each caller identification number of the set of caller identification numbers associated with the geographic location. The assigning step may include assigning the caller identification number associated with the highest determined answer rate to the outbound call.

In any implementations, the assigning step may include filtering the set of caller identification numbers based on one or more criterion. The assigning step may include assigning the caller identification number from the filtered set of caller identification numbers to the outbound call.

In any implementations, the one or more criterion may include one or more caller identification restrictions associated with the specified telephone number. The one or more criterion may include one or more prior time periods relating to a time period of the request to place the outbound call.

FIG. 1 discloses a (e.g., telephone) communications system 20 according to an implementation. The system 20 may include one or more (e.g., client or customer) networks 22. The system 20 may be operable to connect one or more computing (e.g., telephone or communications) devices 24 of the respective network 22 with various devices of the system 20. The computing devices 24 may include one or more VoIP phones, laptops, desktops, etc. The client network 22 may be established by one or more networking devices, such as servers, routers, switches, etc.

The system 20 may include one or more Session Initiation Protocol (SIP) servers. The SIP servers may include one or more (e.g., client) SIP servers 26 and/or one or more (e.g., host) SIP trunk servers 28. The client server 26 and/or trunk server 28 may be operable to establish one or more SIP trunks 29. The SIP trunk server 28 may include a session border controller (SBC), SIP gateway, etc. The SIP trunk server 28 may be linked to or may otherwise have access to a telephone network 32. The telephone network 32 may include known equipment to facilitate calls in a known manner. The telephone network 32 may be operable to connect one or more computing (e.g., telephone or communications) devices 27 with various devices of the system 20. The computing devices 27 may include any of the devices disclosed herein, such as one or more VoIP phones, laptops, desktops, etc. The devices 24, 27 may be assigned with respective (e.g., end) users. The user may interact with the device 24/27 directly and/or remotely. The devices 24, 27 may be operable to initiate, receive and/or conduct phone calls, including between each other.

The telephone network 32 may support one or more phone numbers. The SIP trunk server 28 may be operable to interconnect the client server 26 and the telephone network 32 via the internet 30. The host server 28 may be remote from the SIP trunk 29. The client server 26 may be operable to interconnect the trunk 29 and the telephone network 32. For every incoming or outgoing phone call across the trunk 29, one SIP channel may be established. The SIP channel may support one or more calls conducted at different times. Each call may include an audio stream having two or more channels. The audio stream may be established in response to a first user (e.g., callee) answering the incoming call from the respective device 24/27, which may be initiated by a second user (e.g., caller) from another respective device 24/27. The trunk 29 may be operable to interconnect one or more of the devices 24, 27 to each other. The trunk 29 may be operable to establish a respective SIP channel for phone calls between the devices 24, 27.

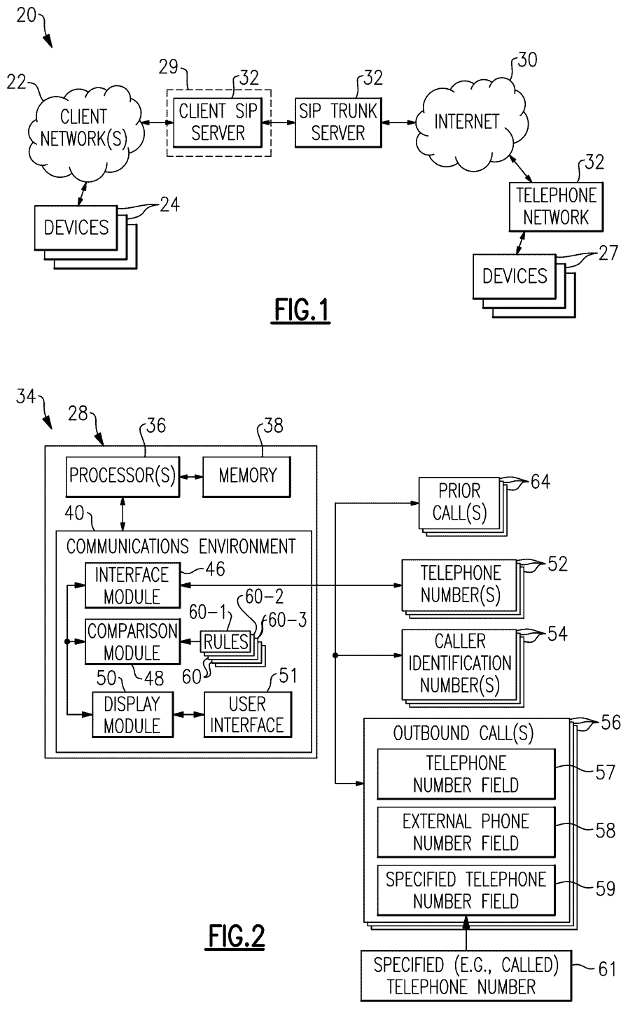

Referring to FIG. 2, with continuing reference to FIG. 1, a (e.g., communications) system 34 for caller identification is disclosed. The system 34 may be incorporated into and/or may otherwise interface with the system 20. The system 34 may be incorporated into any of the devices of the system 20, such as the client server 26 and/or the trunk server 28. The system 34 may be operable to establish VoIP communications across the SIP trunk 29.

The system 34 may include one or more computing (e.g., communications) devices. Each computing device may include one or more computer processors, memory, storage means, network devices, input and/or output devices, and/or interfaces. The computing devices may be operable to execute one or more software programs, including the functionality of this description. The computing devices may be operable to communicate with one or more networks established by one or more computing devices. The memory may include UVPROM, EEPROM, FLASH, RAM, ROM, DVD, CD, a hard drive, or other computer readable medium which may store data and/or the functionality of this description. The computing devices may be a desktop computer, laptop computer, smart phone, tablet, or any other computer device. Input devices may include a keyboard, mouse, touchscreen, etc. The output devices may include a monitor, speakers, printers, etc. Each of the computing devices may include one or more processors coupled to memory. The computing devices may be coupled to each other by connection(s). The connection may be a wired and/or wireless connection. The connection may be established over one or more networks and/or other computing systems.

The system 34 may be operable to assign caller identification number(s) to one or more outgoing calls, which may be initiated by various devices of the system 20, such as the devices 24. The outgoing call may be initiated by a respective computing device, which may be assigned a respective (e.g., outbound) telephone number. The system 34 may be operable to assign a caller identification number to the outbound call, which may be the same or may differ from the assigned telephone number of the computing device.

The system 34 may include one or more processors 36 coupled to memory 38. In implementations, a SIP server may include the processor(s) 36, such as the client SIP server 26 and/or SIP trunk server 28. The processor(s) 36 may be collectively operable to execute a communications environment 40. The communications environment 40 may be operable to execute any of the functionality disclosed herein.

The communications environment 40 may be operable to assign caller identification number(s) to one or more outgoing calls. The communications environment 40 may be executable on a single computing device or may be distributed between two or more computing devices. The communications environment 40 may be executable on the trunk server 28 and/or client server 26. In implementations, portions of the communications environment 40 may be distributed between the trunk server 28 and/or client server 26. In implementations, the trunk server 28 may be operable to execute the communications environment 40. The client server 26 may be operable to interact with the communications environment 40 through a thin-client or web browser.

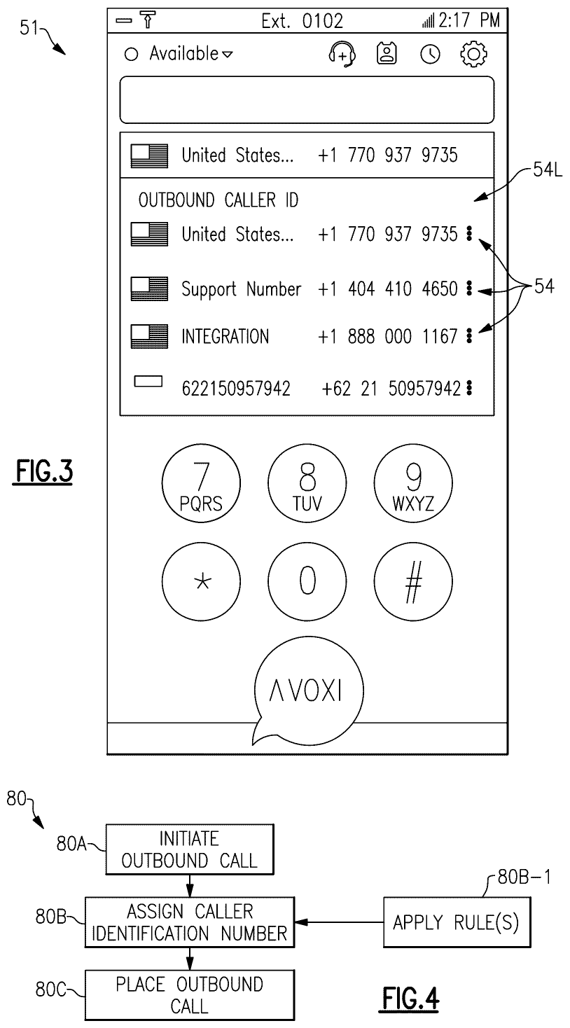

The system 34 may include a (e.g., graphical) user interface 51 operable to display various information regarding one or more phone calls. A user may interact with the user interface 51 to configure one or more parameters associated with the communications environment 40 and/or view the information, such as a caller identification number. FIG. 3 discloses an implementation of the user interface 51.

The communications environment 40 may include one or more modules operable to configure and/or place outbound call(s). The communications environment 40 may include one or more modules operable to assign caller identification number(s) to the outbound call(s).

The communications environment 40 may include an interface module 46, a comparison module 48 and/or a display module 50. Although three modules are disclosed, fewer or more than three modules may be utilized to provide the disclosed functionality, including only one module. The display module 50 may be operable to cause the user interface 51 to display various information, including any of the information disclosed herein, such as one or more selectable caller identification numbers.

The interface module 46 may be operable to access data associated with telephone calls established across a communications system, such as the system 20. The interface module 46 may be operable to access one or more sets of (e.g., assignable) telephone numbers 52 and/or one or more sets of caller identification (ID) numbers 54. The sets of telephone numbers 52 and/or caller ID numbers 54 may be stored in memory 38 and/or another (e.g., external) memory location. The communications environment 40 and/or another portion of the system 20 may be operable to assign the telephone numbers 52 to one or more of the respective computing devices 24. The interface module 46 may be operable to access the data in response to initiation of at least one outbound call 56, which may be associated with the trunk 29. The outbound call 56 may be initiated by the client server 26 and/or one of the devices 24. The outbound call 56 may be initiated by a respective (e.g., outbound) telephone number 52, which may be assigned to a respective computing device, such as one of the devices 24.

The comparison module 48 may be operable to assign caller identification number(s) 54 to outbound call(s) 56 associated with the respective telephone number(s) 52 utilizing various techniques, including any of the techniques disclosed herein. The assigned caller identification number 54 may be the same or may differ from the outbound telephone number 52 associated with the outbound call 56.

The comparison module 48 may be operable to assign a caller identification number 54 from a set of caller identification numbers 54 to an outbound call 56 based on one or more (e.g., predefined) criterion. The criterion may include one or more rules 60 and/or set(s) of rule(s) 60. The rules 60 may include one or more logical operations (e.g., conditions). The set of rules 60 may be associated with a hierarchy. The comparison module 48 and/or another portion of the communications environment 40 may be operable to assign the caller identification number(s) 54 to the outbound number(s) 56 based on the hierarchy.

Each outbound call 56 may be associated with one or more parameters (e.g., fields). In implementations, the parameters may include an (e.g., internal or assigned) telephone number field 57, an (e.g., external) telephone number field 58 and/or a specified telephone number field 59. The parameters may be stored according to one or more predefined data structures. The comparison module 48 and/or another portion of the communications environment 40 may be operable to assign (e.g., store) the telephone number 52 requesting the outbound call to the internal telephone number field 57. Each outbound call 56 may be associated with a specified (e.g., called or dialed) telephone number 61. The called number 61 may be indicated during initiation of the request to place the outbound call 56 (e.g., from a caller to a callee). The comparison module 48 may be operable to assign (e.g., store) the called number 61 to the specified telephone number field 59 of the outbound call 56. The comparison module 48 may be operable to store the assigned caller identification number 54 in the external phone number field 58 associated with the outbound call 56.

The comparison module 48, another portion of the communications environment 40 and/or system 20 may be operable to place the outbound call 56 from the outbound telephone number 52 to the called number 61 using the assigned caller identification number 54. The comparison module 48 may be operable to cause the outbound call 56 to be placed based on the rule(s) 60. In implementations, the criterion and/or rule(s) 60 may be associated with at least one prior call relating to the called number 61.

The set of rules 60 may include a (e.g., first) rule 60-1, which may be operable to cause the communications environment 40 to assign a caller identification number 54 to the outbound call 56 in response to user input (e.g., interaction). In implementations, a user (e.g., agent) may interact with an associated computing device 24 to (e.g., manually) specify (e.g., select) a caller identification number 54.

Various techniques may be utilized to specify the caller identification number 54. In implementations, the user may input the caller identification number 54 using a keypad and/or another input of the computing device 24. The user may specify (e.g., dial) a preprogrammed (e.g., star) code when initiating the outbound call 56. The preprogrammed code(s) may be stored locally in the memory of the respective device 24. In other implementations, the preprogrammed code(s) may be stored in memory 38 and may be accessible by two or more devices 24 associated with the client network 22. The preprogrammed code(s) may be associated with respective preassigned caller identification number(s) 54. In a scenario, when calling to a phone number 1-770-937-9735 the agent may dial 321*17709379735. The communications environment 40 may be operable to query the star code value 321 in a database and/or another memory location and assign the corresponding caller identification number 54 to the outbound call 56. Two or more users of the devices 24 (e.g., a sales team) may utilize a common set of star codes.

The user may interact with the user interface 51 to select or otherwise specify the caller identification number 54. The first rule 60-1 may be operable to cause the comparison module 48 to assign a caller identification number 54 to the outbound call 56 in response to user interaction. In the implementation of FIG. 3, a user may interact with the user interface 51 to cause the communications environment 40 to assign a caller identification number 54 from a (e.g., drop down) list 54L of selectable caller identification numbers 54. Selecting the caller identification number 54 may provide the user with a control (e.g., override) function.

The comparison module 48 may be operable to query (e.g., search) list(s) of (e.g., recent) prior calls 64 between the network 22 and the called telephone number 61. In implementations, the set of rules 60 may include a (e.g., second) rule 60-2, which may be operable to cause the comparison module 28 to query list(s) of the prior calls 64 to and/or from the network 22 associated with the outbound telephone number 52. For the purposes of this disclosure, the term “recent” means a limited duration from initiation of the outbound call unless otherwise indicated. The list may include at least 100, 1000 or more prior calls 64. In implementations, the prior calls 64 may include one or more call backs from the called number 61, such as a call back associated with a hotel or car rental reservation. The comparison module 48 may be operable to assign the call back number as the caller identification number 54, which may improve a likelihood of the callee answering the call.

Each entry of the list of prior calls 64 may be associated with a respective caller identification number 54 of the set of caller identification numbers 54. The list(s) of prior calls 64 may be stored in one or more prior call logs. The prior calls 64 may be identified by one or more parameters, such as outbound call number, inbound call number, time, date, geographical location, etc.

Various list(s) of prior calls 64 may be utilized. The list of prior calls 64 may be limited to a specified duration (e.g., last 7 or 30 days). The list of prior calls 64 may include one or more inbound calls, which may include at least one inbound call placed by the called number 61. The list of prior calls 64 may include one or more (e.g., answered) outbound calls placed by one or more devices 24 of the client network 22.

The comparison module 48 may be operable to establish the list(s) of prior calls 64 by applying one or more filters to the prior calls 64. The first rule 60-1 may be operable to cause the comparison module 48 to filter the entries in the list of prior calls 64 based on one or more caller identification restrictions associated with the called number 61. The caller identification restriction(s) may be associated with a geographic location of the called number 61. The geographic location may include a country, region (e.g., state or province) and/or time zone of the called number 61. Toll free numbers may not be permitted in most parts of the world. In implementations, toll free numbers may be excluded from the list of caller identification numbers 54 based on a geographic location associated with the called number 61. The comparison module 48 may be operable to exclude any toll free numbers from a list of eligible caller identification numbers 54 based on geographic location. The first rule 60-1 may be operable to cause the comparison module 48 to assign the caller identification number 54 associated with the at least one entry in the list of prior calls 64 to the outbound call 56 based on the filter(s).

The second rule 60-2 may be operable to cause the comparison module 48 to identify at least one entry in the list of prior calls 64 associated with the called number 61. The comparison module 48 may be operable to identify any entries in the list of prior calls 64 associated with the called number 61. The second rule 60-2 may be operable to cause the comparison module 48 to assign the caller identification number 54 associated with the identified entry to the outbound call 56. In implementations, the second rule 60-2 may be operable to cause the comparison module 48 to assign the caller identification number 54 associated with a most recent call in the list of prior calls 64 associated with the called number 61 in response to identifying two or more entries in the list of prior calls 64 associated with the called number 61. The comparison module 48 may be operable to assign the most recent called number in response to identifying one or more matches in the list of prior calls 64.

The comparison module 48 may be operable to assign the caller identification number 54 based on a geographic location associated with the called number 61 of the outbound call 56. The geographic location may be associated with a country, region (e.g., state or province) and/or time zone. The set of rules 60 may include a (e.g., third) rule 60-3 operable to cause the comparison module 48 to identify the geographic location associated with the called number 61. The third rule 60-3 may be operable to cause the comparison module 48 to determine an answer rate for each caller identification number 54 within a set of caller identification numbers 54 associated with the geographic location. The comparison module 48 may be operable to apply one or more (e.g., predefined) filters to the set of caller identification numbers 54 to establish a filtered list based on the geographic location, such as by country, region and/or time zone.

The comparison module 48 may be operable to evaluate a (e.g., global) pool of prior calls 64 associated with two or more client networks 22 and/or client SIP servers 26 connected to a common SIP trunk server 28. In implementations, the comparison module 48 may be operable to evaluate two or more lists of prior calls 64 associated with the geographic location. The lists of prior calls 64 may be associated with two or more respective client networks 22, which may be assigned (e.g., allocated) respective (e.g., distinct) sets of telephone numbers 52 and/or caller identification numbers 54. The lists of prior calls 64 of the respective client networks 22 may differ from each other.

The third rule 60-3 may be operable to cause the comparison module 48 to filter (e.g., limit) the set of caller identification numbers 54 to one or more prior time periods relating to a time period of the request to place the outbound call 56. The prior time period(s) may associated with an hour and/or day of the week common with the outbound call 56. The comparison module 48 may be operable to determine the answer rates of the caller identification numbers 54 associated with the filtered time period(s). Various techniques may be utilized to establish the prior time period(s), including one or more machine learning models (e.g., neural networks) trained on prior call activity. The prior call activity may be limited by various criterion including an industry and/or sector associated with the called number 61.

The filtered list may include only one, or more than one, caller identification number 54 associated with the geographic location. In scenarios in which the filtered list may include only one caller identification number 54 associated with the geographic location, the comparison module 48 may be operable to assign the caller identification number 54 to the outbound call 56. In scenarios in which the filtered list may include more than one caller identification number 54 associated with the geographic location, the comparison module 48 may be operable to assign the caller identification number 54 associated with the highest determined answer rate to the outbound call 56.

FIG. 4 discloses a method of caller identification in a flow chart 80 according to an implementation. The method 80 may be utilized to assign caller identification number(s) to outbound call(s) between two or more communications (e.g., end user) devices. The method 80 may include assigning the caller identification number(s) based on one or more (e.g., predefined) criterion, including any of the criterion and/or rules disclosed herein. Fewer or additional steps than are recited below could be performed within the scope of this disclosure, and the recited order of steps is not intended to limit this disclosure. The communications environment 40 may be programmed with logic for performing method 80. Reference is made to the systems 20, 34.

At block 80A, an outbound call 56 may be initiated by a (e.g., end user) communications device. The call may be established between any of the devices of the system 20. The outbound call 56 may be associated with an outbound telephone number 52 associated with a first user (e.g., caller) and/or a specified (e.g., called or dialed) telephone number 61 associated with a second user (e.g., callee). Block 80A may include receiving a request to place the outbound call 56 from the outbound telephone number 52 to the called number 61.

At block 80B, a caller identification number 52 may be assigned to the outbound call 56. The caller identification number 52 may be assigned utilizing any of the techniques disclosed herein. Block 80B may be performed by a SIP server that interconnects a first device associated with the outbound telephone number 52 and a second device associated with the called number 61.

Block 80B may include selecting a caller identification number 52 from a (e.g., eligible, filtered) set of caller identification numbers 52. Block 80B may include assigning the caller identification number 52 to the outbound call 56 based on one or more (e.g., predefined) criterion and/or rules 60 at block 80B-1, including any of the criterion and/or rules disclosed herein. Block 80B-1 may include assigning the caller identification number 54 from a set of caller identification numbers 54 to the outbound call based on a set of rules 60. The caller identification number 54 may be the same or may differ from the outbound telephone number 52. The set of rules 60 may be associated with at least one prior call relating to the called number 61.

Block 80B may include querying a list of prior (e.g., recent) calls 64 associated with the outbound telephone number 52 and/or called number 61. Each entry of the list of prior calls 64 may be associated with a respective caller identification number 54 of the set of caller identification numbers 54. Block 80B may include identifying at least one entry in the list of prior calls 64 associated with the called number 61. Block 80B may include assigning the caller identification number 54 associated with the identified entry to the outbound call 56.

Block 80B may include determining a most recent call in the list of prior calls 64 to and/or from the called number 61. The caller identification number 54 associated with the most recent call may be assigned to the outbound call 56.

Block 80B may include identifying a geographic location associated with the called number 61. Block 80B may include determining an answer rate associated with each caller identification number 54 of the set of caller identification numbers 54 associated with the geographic location. The caller identification number 54 associated with the highest determined answer rate may be assigned to the outbound call 56.

Block 80B may include filtering the set of caller identification numbers 54 based on one or more criterion, including any of the criterion disclosed herein. A caller identification number 54 may be selected from the filtered set, which may include one or more eligible caller identification numbers 54. The caller identification number 54 may be selected utilizing any of the techniques disclosed herein. The criterion may include one or more caller identification restrictions associated with the called number 61. The criterion may include one or more prior time periods relating to a time period of the request to place the outbound call 56. The selected caller identification number 54 may be assigned to the outbound call 56.

At block 80C, the outbound call 56 may be placed to the called number 61 using the assigned caller identification number 54. The outbound call 56 may be placed by the system 20 (FIG. 1).

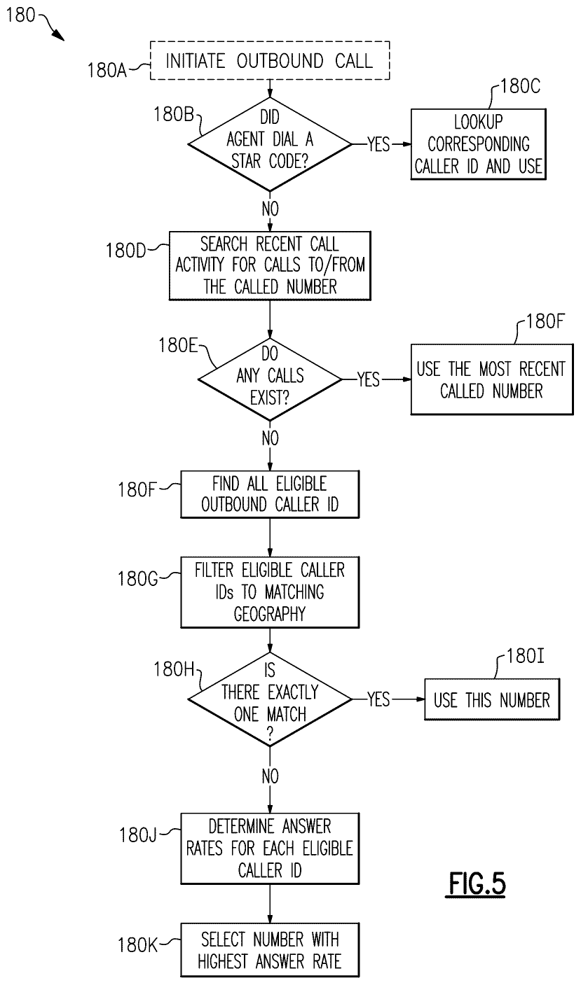

FIG. 5 discloses a method of caller identification in a flow chart 180 according to an implementation. The method 180 may be utilized to assign caller identification number(s) to outbound call(s) between two or more communications (e.g., end user) devices. The method 180 may include assigning the caller identification number(s) based on one or more (e.g., predefined) criterion, including any of the criterion and/or rules disclosed herein. Fewer or additional steps than are recited below could be performed within the scope of this disclosure, and the recited order of steps is not intended to limit this disclosure. The communications environment 40 may be programmed with logic for performing method 180. The method 80 may incorporate any of the features of the method 180 and/or vice versa. Reference is made to the systems 20, 34.

At block 180A, an outbound call 56 may be initiated between two or more (e.g., end) user devices. The outbound call 56 may be associated with an outbound telephone number 52 associated with a first user (e.g., caller) and/or a specified (e.g., called) telephone number 61 associated with a second user (e.g., callee). Block 180A may include receiving a request to place the outbound call 56 from the outbound telephone number 52 to the called number 61.

When an outbound call 56 is initiated (e.g., attempted) one or more criterion and/or rules may be applied to assign (e.g., select) an outbound caller identification number 54. The method 180 may include one or more rules and/or decisions. The rules may be associated with a hierarchy. At block 180B, the method may include determining whether a user input associated with a caller identification number 54 has been received. The user input may include any of the inputs disclosed herein, such as a (e.g., predefined) star code or selection from a user interface. A lookup may be performed to determine a caller identification number 54 associated with the respective star code. The determined or selected caller identification number 54 may be assigned to the outbound call 56 at block 180C.

One or more criterion may be evaluated in response to the absence of user input associated with initiation of the outbound call 56 at block 180B. The criterion may be associated with respective rules. In implementations, at least one prior call 64 relating to the called number 61 may be evaluated.

At block 180D, prior call activity may be searched for any calls from the called number 61. The prior call activity may be associated with a list of one or more prior calls 64. The prior call activity and/or lists may be filtered utilizing any of the techniques disclosed herein.

At block 180E, the method may include determining whether any calls to and/or from the called number 61 exist in the prior call activity. The most recent called number 52/54 by the called number 61 may be assigned as the caller identification number 54 for the outbound call 56.

At block 180F, all eligible outbound caller identification numbers 54 from the list(s) of caller identification numbers 54 may be determined utilizing any of the techniques disclosed herein. The eligible caller identification numbers 54 may be the same number or may be fewer than the total number of available caller identification numbers 54, which may be allocated to the client network 22.

At block 180G, the eligible outbound caller identification number(s) 54 may be filtered utilizing one or more criterion. In implementations, the eligible caller identification number(s) 54 may be filtered based on a geographic location associated with the called telephone number 61.

At block 180H, the method may include determining whether there may be exactly one filtered result (e.g., match) from the eligible caller identification number(s) 54. The caller identification number(s) 54 associated with the filtered result may be assigned to the outbound call 56 at block 180I.

At block 180J, the method may include determining the answer rate for each eligible caller identification number 54 in response to determining two or more filtered results at block 180H. At block 180K, the caller identification number 54 associated with the highest answer rate may be assigned to the outbound call 56.

The disclosed systems and methods may be useful in improving a likelihood that a telephone call is answered. Callees may be more likely to answer calls leading to higher efficacy for users making the outbound calls.

Although the different examples have the specific components shown in the illustrations, embodiments of this disclosure are not limited to those particular combinations. It is possible to use some of the components or features from one of the examples in combination with features or components from another one of the examples.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A communications system comprising:
one or more processors coupled to memory, wherein the one or more processors are collectively operable to execute a communications environment, and the communications environment is operable to:
receive a request to place an outbound call from an outbound telephone number to a specified telephone number;
assign a caller identification number from a set of caller identification numbers to the outbound call based on one or more criterion associated with at least one prior call relating to the specified telephone number, wherein the caller identification number differs from the outbound telephone number; and
place the outbound call from the outbound telephone number to the specified telephone number using the assigned caller identification number.

2. The system as recited in claim 1, further comprising:
a Session Initiation Protocol (SIP) server comprising the one or more processors.

3. The system as recited in claim 1, wherein the communications environment is operable to:
query a list of prior calls to and/or from a first network associated with the outbound telephone number, wherein each entry of the list of prior calls is associated with a respective caller identification number of the set of caller identification numbers;
identify at least one entry in the list of prior calls associated with the specified telephone number; and
assign the caller identification number associated with the at least one entry to the outbound call.

4. The system as recited in claim 3, wherein the communications environment is operable to:
assign the caller identification number associated with a most recent call in the list of prior calls associated with the specified telephone number in response to identifying the at least one entry in the list of prior calls associated with the specified telephone number.

5. The system as recited in claim 3, wherein:
the list of prior calls includes one or more inbound calls.

6. The system as recited in claim 5, wherein:
the one or more inbound calls include at least one inbound call placed by the specified telephone number.

7. The system as recited in claim 3, wherein:
the list of prior calls include one or more answered outbound calls placed by one or more devices of the first network.

8. The system as recited in claim 3, wherein the communications environment is operable to:
filter the entries in the list of prior calls based on one or more caller identification restrictions associated with the specified telephone number; and
assign the caller identification number associated with the at least one entry to the outbound call based on the filter.

9. The system as recited in claim 8, wherein:
the one or more caller identification restrictions are associated with a geographic location of the specified telephone number.

10. The system as recited in claim 9, wherein:
the geographic location includes a country and/or region of the specified telephone number.

11. The system as recited in claim 1, wherein the communications environment is operable to:
identify a geographic location associated with the specified telephone number;
determine an answer rate for each caller identification number of the set of caller identification numbers associated with the geographic location; and
assign the caller identification number associated with the highest determined answer rate to the outbound call.

12. The system as recited in claim 11, wherein the communications environment is operable to:
limit the set of caller identification numbers to one or more prior time periods relating to a time period of a request to place the outbound call.

13. The system as recited in claim 1, wherein:
the one or more criterion include a set of rules associated with a hierarchy; and
the communications environment is operable to assign the caller identification number based on the hierarchy.

14. A method of caller identification comprising:
receiving a request to place an outbound call from an outbound telephone number to a specified telephone number;
assigning a caller identification number from a set of caller identification numbers to the outbound call based on at least one prior call relating to the specified telephone number, wherein the caller identification number differs from the outbound telephone number; and
placing the outbound call to the specified telephone number using the assigned caller identification number.

15. The method as recited in claim 14, wherein:
the assigning step is performed by a Session Initiation Protocol (SIP) server that interconnects a first device associated with the outbound telephone number and a second device associated with the specified telephone number.

16. The method as recited in claim 14, wherein the assigning step comprises:
querying a list of prior calls associated with the outbound telephone number, wherein each entry of the list of prior calls is associated with a respective caller identification number of the set of caller identification numbers;
identifying at least one entry in the list of prior calls associated with the specified telephone number; and
assigning the caller identification number associated with the at least one entry to the outbound call.

17. The method as recited in claim 16, wherein the assigning step comprises:
determining a most recent call in the list of prior calls from the specified telephone number; and
assigning the caller identification number associated with the most recent call to the outbound call.

18. The method as recited in claim 14, wherein the assigning step comprises:
identifying a geographic location associated with the specified telephone number;
determining an answer rate associated with each caller identification number of the set of caller identification numbers associated with the geographic location; and
assigning the caller identification number associated with the highest determined answer rate to the outbound call.

19. The method as recited in claim 14, wherein the assigning step comprises:
filtering the set of caller identification numbers based on one or more criterion; and
assigning the caller identification number from the filtered set of caller identification numbers to the outbound call.

20. The method as recited in claim 19, wherein:
the one or more criterion includes one or more caller identification restrictions associated with the specified telephone number; and/or
the one or more criterion includes one or more prior time periods relating to a time period of the request to place the outbound call.
